(19) United States
(12) Patent Application Publication
(10) Pub. No.: US 2023/0418539 A1
(43) Pub. Date: Dec. 28, 2023

(54) CONTENT OUTPUT CONTROL DEVICE, CONTENT OUTPUT CONTROL METHOD, AND NON-TRANSITORY COMPUTER READABLE STORAGE MEDIUM

(71) Applicant: DENSO CORPORATION, Kariya-city (JP)

(72) Inventors: Takuya KONDO, Kariya-city (JP); Daiki KAWASHIMA, Kariya-city (JP); Kentaro TESHIMA, Kariya-city (JP)

(21) Appl. No.: 18/461,348

(22) Filed: Sep. 5, 2023

Related U.S. Application Data
(63) Continuation of application No. PCT/JP2022/006183, filed on Feb. 16, 2022.

(30) Foreign Application Priority Data
Mar. 9, 2021 (JP) 2021-037390

(51) Int. Cl. G06F 3/14

(52) U.S. Cl. CPC G06F 3/1423; G06F 3/147

(57) ABSTRACT

A content output control device includes a memory, an arbitration unit, and an output control unit. The memory stores a rule definition including: an arbitration policy for defining basic arbitration when one of contents is assigned to an area or a zone; and a constraint expression. The arbitration unit performs arbitration of the contents according to the rule definition to satisfy a rule-based arbitration upon receiving an output request from an application. The output control unit controls an output of the one of the contents assigned to the area or the zone due to the arbitration of the contents by the arbitration unit. The arbitration unit determines an output order of the contents, and performs the arbitration of the contents by using a result of determining the output order so as to satisfy the rule-based arbitration.

### CROSS REFERENCE TO RELATED APPLICATIONS

The present application is a continuation application of International Patent Application No. PCT/JP2022/006183 filed on Feb. 16, 2022, which designated the U.S. and claims the benefit of priority from Japanese Patent Application No. 2021-037390 filed on Mar. 9, 2021. The entire disclosures of all of the above applications are incorporated herein by reference.

### TECHNICAL FIELD

The present disclosure relates to a content output control device, a content output control method, and a non-transitory computer readable storage medium.

### BACKGROUND

In rule-based arbitration (references: arbitration logic specification in US 2014/0285398 A1 and US 2014/0327533 A1 and rule-based syntax definition in US 2021/0031629 A1, which are incorporated herein by reference), areas or zones are defined as the arbitration target in descending order of value of the areas or the zones by one-pass logic, and content is assigned to each area or zone. The constraint expressions are evaluated after assigning the content, when all the constraint expressions are true (i.e., satisfied), the content assignment is successful, and when any constraint expression is false (i.e., not satisfied), the next content is assigned and the constraint expressions are evaluated again. When the content is not assigned to the area or the zone, or when no content is capable of being assigned to the area or the zone, it moves to the next area or zone. In this case, it may not be possible to obtain the result as intended by the specification developer who wants to design that the right side is established after the left side is established, since there is no weight on the right side and the left side. On the other hand, according to a conceivable technique, when the left side of the constraint expression is established and the right side has already been determined, the logic of re-arbitrating the area or zone on the right side is used.

### SUMMARY

According to an aspect of the present disclosure, a content output control device includes a memory, an arbitration unit, and an output control unit. The memory stores a rule definition including: an arbitration policy for defining basic arbitration when one of contents is assigned to an areas or a zone; and a constraint expression. The arbitration unit is configured to perform arbitration of the contents according to the rule definition to satisfy a rule-based arbitration upon receiving an output request from an application. The output control unit is configured to control an output of the one of the contents assigned to the area or the zone due to the arbitration of the contents by the arbitration unit. The arbitration unit is configured to determine an output order of the contents, and to perform the arbitration of the contents by using a result of determining the output order so as to satisfy the rule-based arbitration.

### BRIEF DESCRIPTION OF DRAWINGS

Objects, features and advantages of the present disclosure will become apparent from the following detailed description made with reference to the accompanying drawings. In the drawings:

FIG. 1 is a functional block diagram showing a configuration of a display control device according to an embodiment;

FIG. 2 is a perspective view showing a vehicle compartment;

FIG. 3 is a diagram showing a priority arbitration;

FIG. 4 is a diagram showing a latter-win arbitration;

FIG. 5 is a diagram showing the relationship between Z-orders of areas and priorities;

FIG. 6 is a diagram showing the relationship between contents, states, and areas;

FIG. 7 is a diagram showing the definition of truth values;

FIG. 8 is a diagram showing the data structure of a constraint expression object;

FIG. 9 is a diagram showing a truth value in a case where an evaluation value is true when a left side of a constraint expression is false;

FIG. 10 is a diagram showing the relationship between area priorities and constraint expressions;

FIG. 11 is a diagram showing an example where a constraint expression is different from a specification developer's intention;

FIG. 12 is a flow chart showing the behavior of the overall arbitration logic;

FIG. 13 is a flowchart showing an arbitration process;

FIG. 14 is a diagram showing a concept of an APP request;

FIG. 15 is a diagram for explaining a case where a content is assigned to one area;

FIG. 16 is a diagram for explaining a case where contents are assigned to a plurality of areas;

FIG. 17 is a diagram showing definitions of areas, contents, and constraint expressions;

FIG. 18 is a diagram showing an example of a processing flow of an application;

FIG. 19 is a diagram showing another example of the processing flow of the application;

FIG. 20 is a diagram showing a state transition;

FIG. 21 is a diagram showing an object configuration;

FIG. 22 is a diagram showing a processing flow of an arbitration unit;

FIG. 23 is a diagram showing a mode of assigning contents;

FIG. 24 is a diagram showing another mode of assigning contents;

FIG. 25 is a diagram showing a mode of evaluating constraint expressions;

FIG. 26 is a diagram showing another mode of evaluating constraint expressions;

FIG. 27 is a diagram showing a part of an operation procedure and operation results; and

FIG. 28 is diagram showing another part of the operation procedure and the operation results.

### DETAILED DESCRIPTION

In an arbitration logic according to the conceivable technique, winning or losing of contents with respect to areas or zones is determined, but a content that has lost in the arbitration is not output. Therefore, it is necessary to manage an output request and perform complicated arbitration evaluation on an application side.

According to an aspect of the present disclosure, a content output control device includes a memory, an arbitration unit, and an output control unit. The memory stores a rule definition including: an arbitration policy for defining basic arbitration when one of contents is assigned to an area or a zone; and a constraint expression. The arbitration unit is configured to perform arbitration of the contents according to the rule definition to satisfy a rule-based arbitration upon receiving an output request from an application. The output control unit is configured to control an output of the one of the contents assigned to the area or the zone due to the arbitration of the contents by the arbitration unit. The arbitration unit is configured to determine an output order of the contents, and to perform the arbitration of the contents by using a result of determining the output order so as to satisfy the rule-based arbitration.

Instead of determining winning or losing of the contents with respect to the areas or the zones, the output order of the contents is determined, and the arbitration of the contents is performed using the determination result. By defining the output order of the contents in advance, the output of the contents can be switched according to the output order of the contents. Accordingly, it is possible to appropriately output the content as intended by a specification developer without requiring management of an output request or a complicated arbitration evaluation on an application side.

### Embodiment

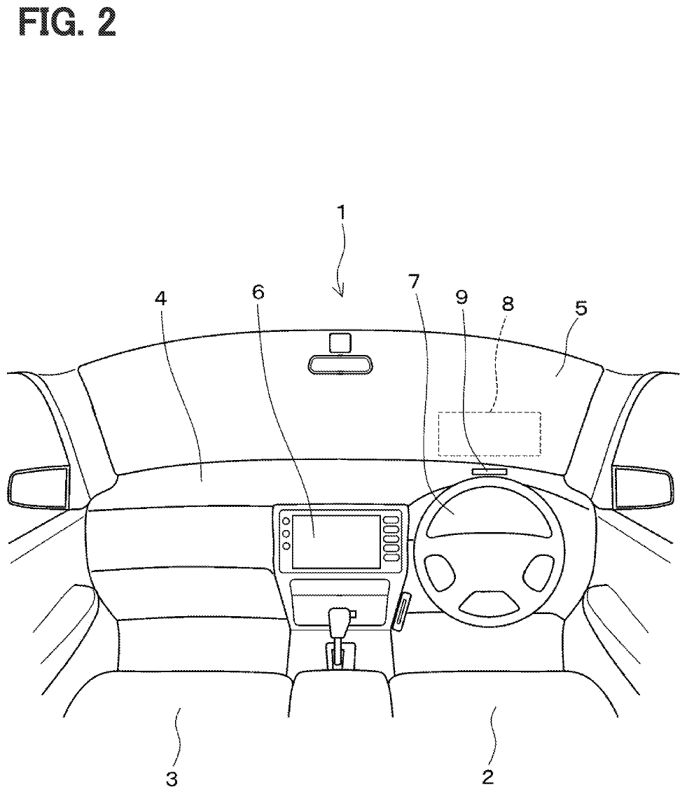

Hereinafter, one embodiment of the present disclosure will be described with reference to the drawings. In this embodiment, a mode in which content is displayed in an area will be described, alternatively, a mode in which content is output as audio in a zone may be also applicable. That is, content output includes both the concept of content display and audio output, and output content includes the concept of both displayed content and audio output content. As shown in FIG. 2, a driver seat 2 and a passenger seat 3 are arranged in a vehicle compartment 1 of a vehicle, and an instrument panel 4 is arranged in front of them. A windshield 5 is mounted on the front end of the instrument panel 4 so as to stand up. A first display device 6 and a second display device 7 are arranged on the instrument panel 4, and a third display device 8 is arranged on the windshield 5.

The first display device 6 is, for example, a center display including a full-color liquid crystal display device, and basically functions as a display unit for displaying a non-traveling system content that is not related to vehicle traveling control. The non-traveling system content includes, for example, map information for navigation, audio information, telephone (TEL) information, and the like. The first display device 6 also functions as a display unit that displays an image of a rear of the vehicle captured by a rear camera when the vehicle is moving backward.

The second display device 7 is, for example, a meter display including a full-color liquid crystal display device, and basically functions as a display unit for displaying a traveling system content that is related to vehicle traveling control. The traveling system content includes, for example, vehicle speed, engine speed, shift position, remaining amount of fuel, and the like.

The third display device 8 is a head-up display in which an image is projected from a display unit 9 arranged on the instrument panel 4 onto the windshield 5, and basically functions as a display unit that displays the traveling system content, similarly to the second display device 7. Each of the display devices 6 to 8 includes one or more areas for displaying contents. In such a configuration, a content is displayed on each of the display devices 6 to 8, thereby providing the occupant with various types of information including the traveling system content and the non-traveling system content.

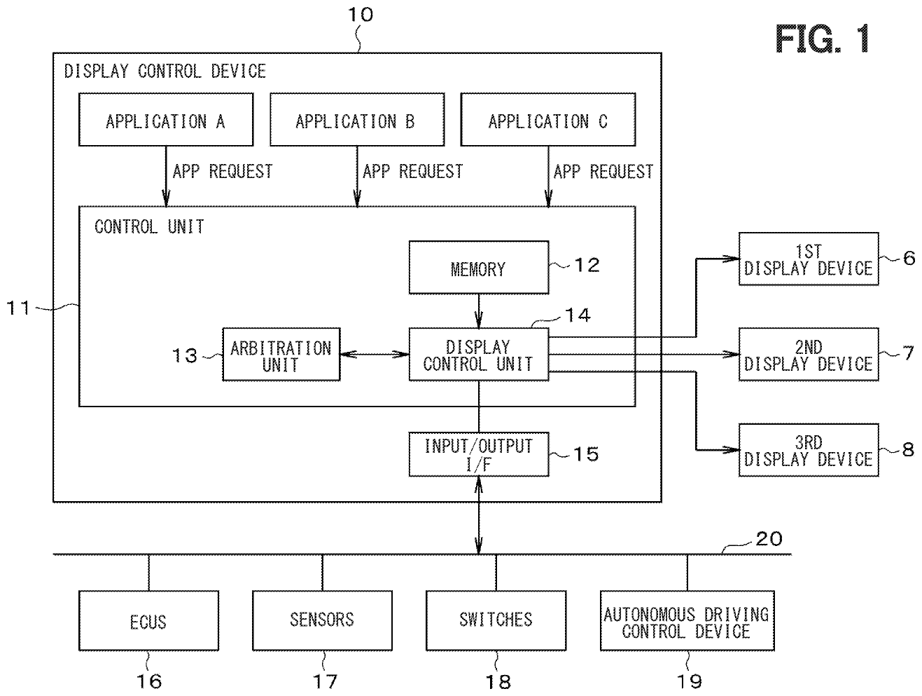

As shown in FIG. 1, a display control device 10 has a control unit 11, and displays contents in areas set in each of the display devices 6-8. The control unit 11 has a microcomputer including a central processing unit (CPU), a read only memory (ROM), a random access memory (RAM), an input/output (I/O), and the like, and executes a display control program stored in a non-transitory tangible storage medium. The display control device 10 corresponds to a content output control device.

Applications A to C are stored in the display control device 10 in advance. When a content display request for a predetermined area of one or more display devices 6 to 8 is generated, each of the applications A to C interrupts and outputs an application request indicating the display device as the display target device, an area, and a content to the control unit 11.

The control unit 11 includes a memory 12, an arbitration unit 13 and a display control unit 14. The display control unit 14 corresponds to an output control unit. The control unit 11 controls the operation of the display control device 10 by executing the output control program. The memory 12 stores rule definitions. The rule definitions include an arbitration policy that define basic arbitration when content is assigned to an area, and a constraint expression that describes properties that should be satisfied exceptionally.

The arbitration policy is always set by any of priority arbitration, latter-win arbitration, and value-based arbitration, as will be described later. The constraint expression may not be limited to one, and no constraint expression may be provided or a plurality of constraint expressions may be provided according to the intention of the specification developer.

Upon receiving the display request from the application, the arbitration unit 13 arbitrates content according to rule definitions so as to satisfy rule-based arbitration. The display control unit 14 is connected to various ECUs 16, various sensors 17, various switches 18, an autonomous driving control device 19 and the like via an input/output I/F 15 through an in-vehicle network 20 such as controller area network (CAN). The display control unit 14 controls display of the content assigned to the predetermined area by the arbitration unit 13. Arbitration logic can be created as a library, and the rule-based arbitration can be arbitrarily set by registering or changing the rule definitions in the library.

When assigning content to areas, different applications may issue APP requests at the same time, in which case arbitration is required. Note that the words “at the same time” does not mean simultaneous in terms of time, but mean the state that, when an APP request is output from an application, the content of another application is already being displayed, i.e., the APP requests from two different applications are in active at the same time.

When the APP requests are turned on at the same time, the content to be displayed in the area needs to be arbitrated. In a configuration that defines all behaviors such as which content is displayed in which area, it becomes difficult to define all behaviors when the number of contents increases. For this reason, in the present embodiment, the rule-based arbitration is adopted such that the rule-based arbitration abstractly indicates which content should be displayed in which area. The rule-based arbitration will be described below.

1. Rule-Based Arbitration

(1) Rule Definition

The rule-based arbitration describes an arbitration method in which the content is arbitrated and assigned to an arbitrary area based on a predetermined rule. Area definitions, content definitions, and constraint expressions are required as rule definitions in rule-based arbitration.

(1-1) Area Definition

The area definition defines the display location, the value of the display location, and the arbitration policy. Since arbitration is performed for each area, an arbitration policy is defined for each area. In the areas, frames for displaying the contents on the display screens of the display devices 6 to 8 are defined. Only one content is assigned to one area.

The area is defined as follows.
(a) The assigned content is displayed in the area.
(b) The area has an arbitration policy.
(c) The area refers to the content that can be displayed.
(d) The area has one or more sizes.

Each area has properties. The priority, Z-order, arbitration policy, and size are set as the properties.

(a) Priority

The priority is a value (in a range between 0% and 100%) indicating the value of the area itself. The arbitration is performed in order from the area with the highest priority value.

(b) Z-Order

The Z-order is a coordinate with respect to a height. The higher the value, the closer to the front it is displayed. When there are areas with the same priority, arbitration is performed in descending order of this value.

(c) Arbitration Policy

The arbitration policy is one of priority arbitration, latter-win arbitration, and value-based arbitration.

(c-1) Priority Arbitration

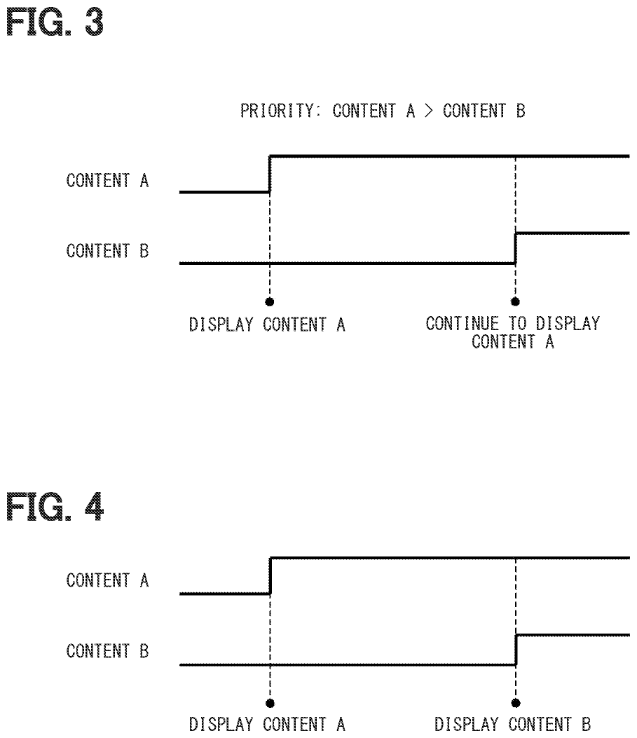

The priority arbitration is an arbitration policy for each area, and as shown in FIG. 3, it is arbitration that displays the content having the highest priority among the contents that can be displayed in the area.

(c-2) Latter-Win Arbitration

The latter-win is an arbitration policy for each area. As shown in FIG. 4, the content of the last request in the area is displayed, and when the display of the last request content is finished, the content of the second last request among the remaining contents is displayed.

(c-3) Value-Based Arbitration

The value-based arbitration is an arbitration policy for the entire area, and is arbitration that displays the content that maximizes the calculated value obtained by multiplying the numerical value that quantifies the value of the content and the numerical value that quantifies the value of the area.

(d) Size

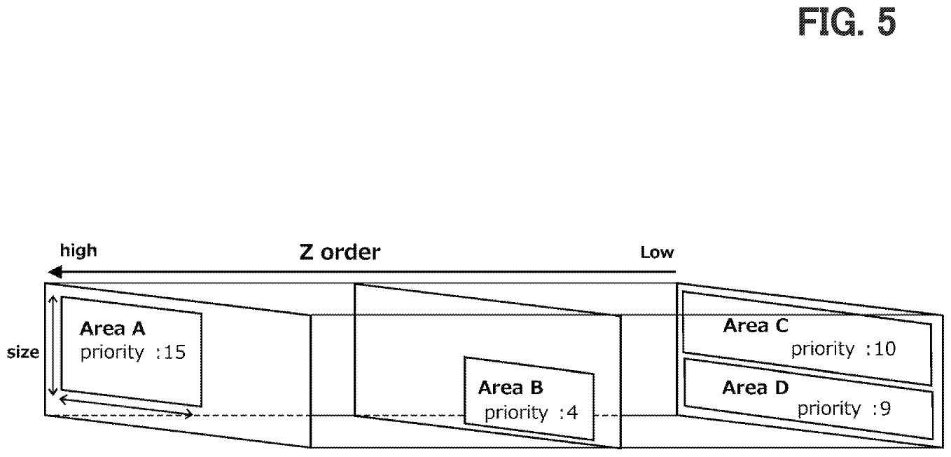

The size is the size of the area, which is defined by a vertical size×a horizontal size. When multiple areas are defined, it is determined according to the size of the content. The relationship between the area Z-order and priority is as shown in FIG. 5.

(1-2) Content Definition

The content definition defines the displayable area, the state of the content, and the value of the state of the content. The content can have multiple states, the content is assigned to the area, and the content status is displayed. The content defines and refers to the area in which the content itself can be displayed. In the contents, the content to be displayed in the area defined on the display screens of the display devices 6 to 8 is defined. Only one content is assigned to one area.

The content is defined as follows.
(a) The content is assigned to the area.
(b) The content refers to one or more areas in which the content itself can be displayed.
(c) The content always has one or more states.
(d) The content has one or more sizes.

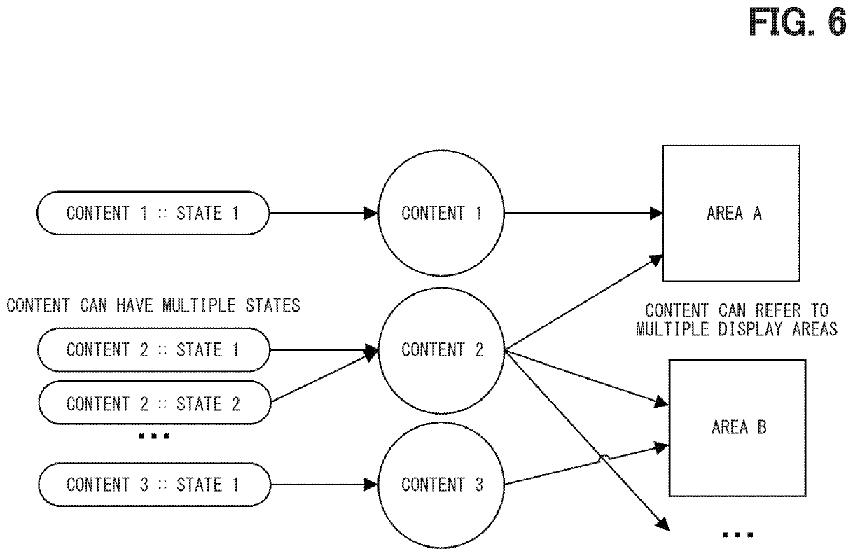

When there are a plurality of displayable areas, the content can be displayable in any one of areas, and one content can be displayed in a plurality of areas at the same time. Each content can have a plurality of states. However, when one content has a plurality of states, each state is exclusive, and the one content can always be displayed only in one state at a time. Each content can have multiple sizes. When one content has multiple sizes, the one content is displayed in a size closest to the size of the display target area. The relationship between the contents, the states, and the areas are linked as shown in FIG. 6.

The content has properties, and priority and whether or not to withdraw the APP request (i.e., good loser) when size arbitration is lost are set as the properties.

(a) Priority

The priority is a value used when the arbitration policy of the area is “priority arbitration”, and the content having a high priority is assigned to the area first.

(b) Size

The size is the display size of the content and is defined by a vertical size×a horizontal size. When more than one sizes are defined, it is determined according to the size of the area.

(1-3) Constraint Expression

A constraint expression is a rule that describes properties that must be exceptionally satisfied during or after arbitration. By suppressing the state of arbitration with a constraint expression, it is possible to express a state that cannot be expressed by the arbitration policy as it is, or to use it for determining the arbitration result after arbitration. That is, for example, depending on a situation such as a traveling state of the vehicle, it may be better not to display even the content assigned by the arbitration policy. The constraint expression defines the conditions for content suppression and area suppression, which are the conditions that the arbitration result must satisfy.

The logical expression that can be handled by the constraint expression are the content state, the area state, the content being displayed in the area, the set of the area and the content, the scene state, the logical operation, and the quantification symbol. The scene is, for example, a manual driving scene or an autonomous driving scene by the autonomous driving control device 19 and output control is possible in which the content of the manual driving content group is not displayed in the autonomous driving scene.
(a) The content state is either active/inactive or displayed/hidden.
(b) The area state is either displayed or hidden.
(c) The logical operations include NOT (!), AND, OR, implication (->), and equal sign (=).

The quantification symbols include ∀ (for all: the condition is satisfied for all elements of the set) and ∃ (exists: at least one element satisfying the condition exists in the set).

(d) Constraint Expression

The constraint expression affects the result of the arbitration logic, and the arbitration logic is set to satisfy all constraints.

(e) Post-Process

Post-process has a property (i.e., good loser) that specifies the waiting for APP requests after arbitration in a particular content. It does not influence the result of the arbitration logic since only the wait state of the content after arbitration changes.

(1-4) Content Suppression

For example, “central area. displaying Content ( )=c1->!c2. is Visible ( )” is exemplified as a constraint expression that a content c2 is not displayed while a content c1 is being displayed. This constraint expression describes the suppression that the content c2 is not displayed when the content c1 is being displayed in the central area.

(1-5) Priority Arbitration and Latter-Win Arbitration

When the priority arbitration and the latter-win arbitration coexist, it is possible to handle them by setting the arbitration policy of the area to the latter-win arbitration and by describing only the relationship between the contents related to the priority with used of the constraint expression. As such a constraint expression, “TEL. is Active ( )->For All MM type interrupt (other than TEL) {x|!x. is Visible ( )}” is exemplified. The arbitration policy is the area of the latter-win arbitration, and describes the suppression that all multimedia type interrupts (other than the telephone) are not displayed when the content with the high priority, i.e., the telephone, is active by adding this constraint expression.

2. Arbitration Logic

The arbitration logic is an algorithm that defines how to assign the content to satisfy a constraint expression based on an area arbitration policy according to a predetermined rule. Basically, each area is arbitrated in order of priority, but when it is determined that the constraint expression with the operator defined by implication is different from the specification developer's intention, the area is returned to the previous area and re-arbitration is performed. The arbitration logic includes arbitration within the area and arbitration for the entire area.

(2-1) Arbitration in the Area

(a) In the arbitration within the area, the area in the priority arbitration and the latter-win arbitration is arbitrated in the descending order of priority.

(b) Evaluate the following feature for each area.

Tentatively assign the highest priority content, and when the evaluation result of the constraint expression is true, determine the tentatively assigned content. When the evaluation result of the constraint expression is false, then re-evaluate the next highest priority content. When there is no content that satisfies the constraint expression, no content is displayed in that area.

(2-2) Arbitration of the Entire Area

The arbitration (i.e., value-based arbitration) for the entire area includes best fit logic and one-pass logic.

(a) The best fit logic selects the highest total value among all the combinations of the contents satisfying the constraint expression and the areas.

(b) The one-pass logic assigns the content with the highest priority to the area in order from the area with the higher priority, and excludes the content already assigned to the other area. In this embodiment, the one-pass logic is adopted, alternatively, the best-fit logic may be adopted.

(2-3) Implications in Constraint Expressions

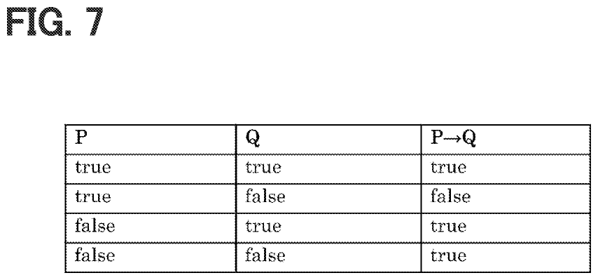

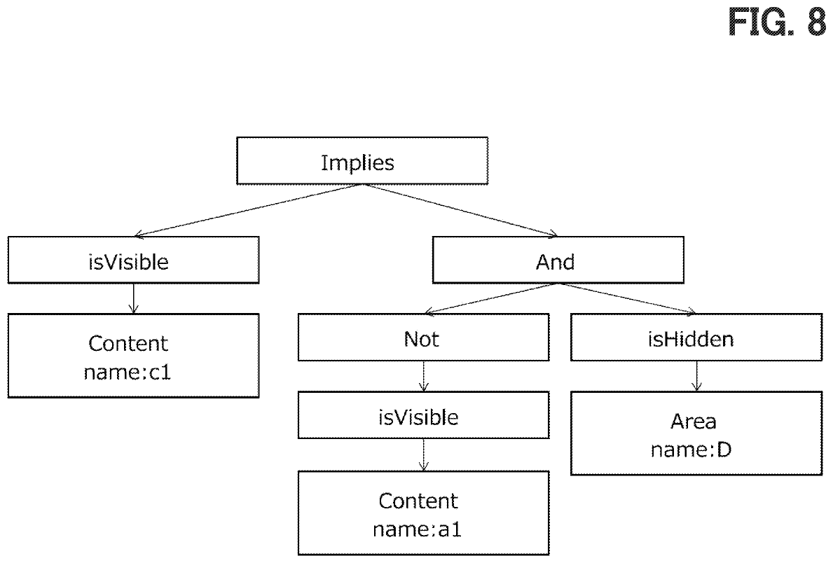

In the arbitration logic, “the implication” in the constraint expression has a meaning as a condition for re-arbitration, so the implication will be explained below. The implication in proposition logic can be described as “P→Q”, and the left side is defined as the premise part and the right side is the conclusion part. If the premise is established, the conclusion is established. The definition of truth values (i.e., truth table) is as shown in FIG. 7. In the axiom system in the proposition logic, the implication is defined as the expression of “P→Q≡¬P V Q”. Also, since the data structure of the constraint expression object is a syntax tree as shown in FIG. 8, it is possible to determine the left side and the right side with the implication.

(2-4) Difference Between Intent and Logical Value in the Implication

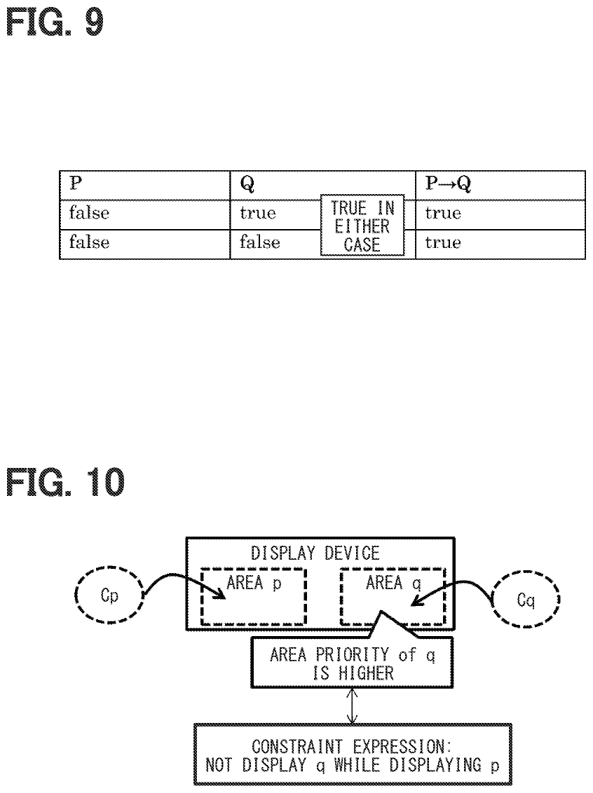

The expression of “P→Q” is true when both P and Q are true. In other words, the constraint expression is true when P is false regardless of Q. When the implication is used in a constraint expression, the specification developer may often intend that “the right side is determined after the left side is established”. That is, the implicit intention is that there is an order, and the right side is to be established after the left side is established. However, logically, after determining the truth of the right side with the implication, if the left side is set to false regardless of the truth of the right side, the result is true. This treatment has no problem in view of the logic, i.e., the semantic theory with the implication. This means that, in order to satisfy the constraint expression by the arbitration logic, the constraint expression can be satisfied by forcibly making all of the left side with the implication false, as shown in FIG. 9. The one-pass logic determines the content assigned to an area according to the priority order of the areas. That is, the left and right sides with the implication are not related. On the other hand, the intention of the constraint expression with the implication is “when the right side is determined after the left side is established”, and the left side and the right side with the implication are related. The purpose of re-arbitration is to solve this difficulty.

The re-arbitration of the constraint expression with the implication will now be described. An example case is described such that a constraint expression is described as “P→Q” and an area p relates to P and an area q relates to Q as shown in FIG. 10. Note that the area priority is defined as “p<q”. A specific example of the constraint expression is “p. is Display ( )->q. is Hidden ( )”, which means “do not display q while displaying p”. The arbitration logic will be described when there are a content Cp related to the area p and a content Cq related to the area q, and APP requests occur at the same time.

(1) First, determine the content of the area q by one-pass logic. As a result, the content Cq is assigned to the area q. In this case, the evaluation of the constraint expression skips the area p since there is an unassigned area on the left side.

(2) The content of the area p as the next area is determined by the one-pass logic as follows. After tentatively assigning the content Cp to the area p, evaluate the constraint expression of “p. is Display ( )->q. is Hidden ( )”. In this case, since the evaluation is defined as “true→false”, the evaluation result of the constraint expression is false. Since the right side with the implication (i.e., the area q) has been arbitrated, the area q is re-arbitrated. Specifically, the assignment of the content Cp is determined as proper, and the assignment of the content in area q is performed again.

(3) The content of area q, which is the next area, is determined as follows since the re-arbitration has been performed. When the content Cq is tentatively assigned to the area q, the evaluation is defined as “true→false”, so that the tentative assignment of the content Cq is cancelled, and no content is assigned to the area q, and then, the process ends.

As a result of the above operation, while the content Cp is being displayed in the area P, the content assignment of the area q is eliminated, and the result as intended by the constraint expression is obtained.

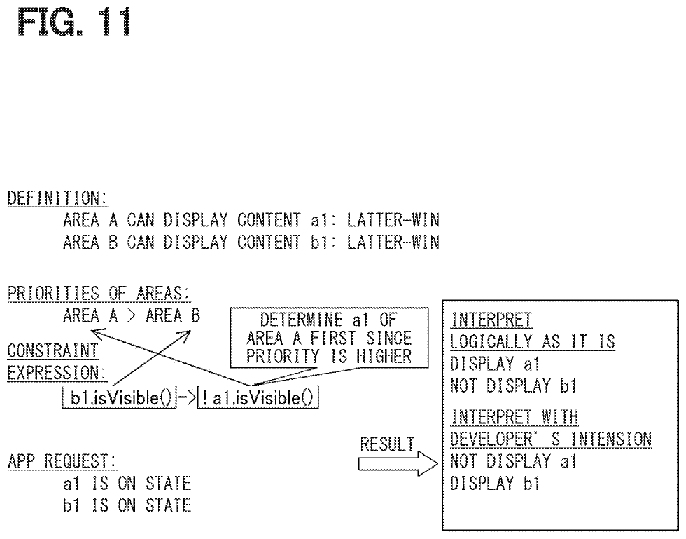

The arbitration logic evaluates the constraint expressions by arbitrating in order from the area with the highest priority. Thus, the right side with the implication (i.e., the conclusion part) may be determined first, and then the left side with the implication (i.e., the premise part) may be determined, according to the description method with the implication in the constraint expression and the level of the priority in the area. In such a case, if all of the left side is set to be false, it is logically correct, but there may be a gap with the specification developer's intention of “after the left side is established” as described above. As such an example, as shown in FIG. 11, an area A can display a content a1 and has the arbitration policy of the latter-win, an area B can display a content b1 and has the arbitration policy of the latter-win, the priority relationship between areas is “the area A>the area B”, and the constraint expression exemplifies “b1. is Visible ( )->!a1. is Visible”. When the APP request is turned on in the order of the content a1 and the content b1, the content a1 is displayed in the area A and then the content b1 is displayed in the area B according to the latter-win arbitration policy. In this case, since the content a1 of the area A with a higher priority is determined first, the right side of the constraint expression is determined first, and the right side of the constraint expression becomes false first. In this case, if the left side of the constraint expression is forcibly set to false, the evaluation result of the constraint expression becomes true. Therefore, if interpreted logically, the content a1 is determined to be displayed, and the content b1 is determined to be not displayed.

However, since the intention of the specification developer is to determine non-display of the content a1 after the content b1 is determined to be displayed, the intention of the specification developer is not reflected. In other words, the arbitration logic should eliminate the gap between the intention of the specification developer and the arbitration behavior as much as possible. As a result, instead of applying arbitration in a one-way starting from the highest priority area, if the constraint expression becomes an unintended state as described above, it is necessary to perform a recursive arbitration logic that arbitrates again. For this reason, this embodiment employs the recursive arbitration logic.

(2-5) Behavior

The recursive arbitration logic includes an arbitration process that assigns the content to an area and a post-process that changes the state of the request after the arbitration process. It also evaluates all constraint expressions to check whether the arbitration process has been successful.

(a) Overall Arbitration Logic Behavior

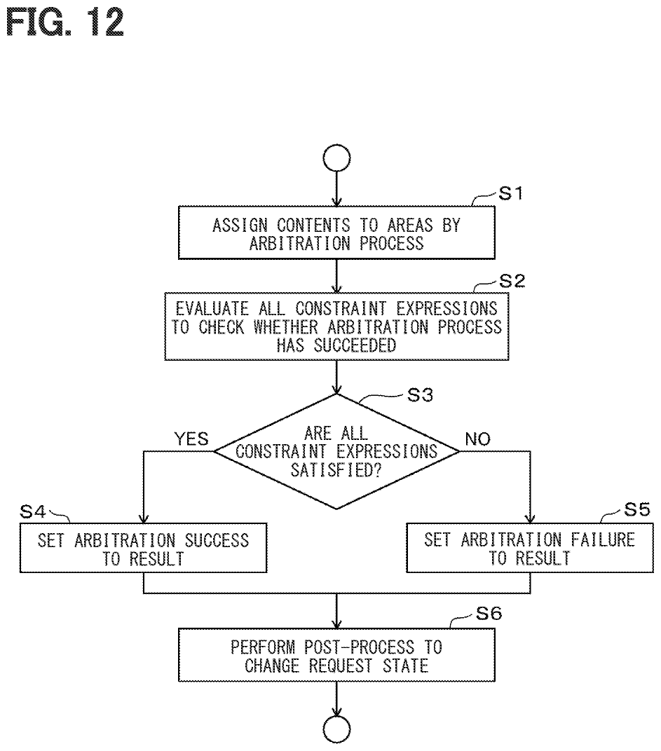

As shown in FIG. 12, the display control device 10 performs arbitration process, assigns contents to areas (at S1), evaluates all constraint expressions, and checks whether the arbitration process has succeeded (at S2). When the display control device 10 determines that all the constraint expressions have been satisfied and determines that the arbitration process has succeeded (“YES” at S3), it sets arbitration success to the result and confirms the arbitration (at S4). When the display control device 10 determines that any one of the constraint expressions is not satisfied and determines that the arbitration process has failed (“NO” at S3), it sets arbitration failure to the result (at S5). The display control device 10 performs post-process and changes the state of the request (at S6).

(b) Operation of Arbitration Process

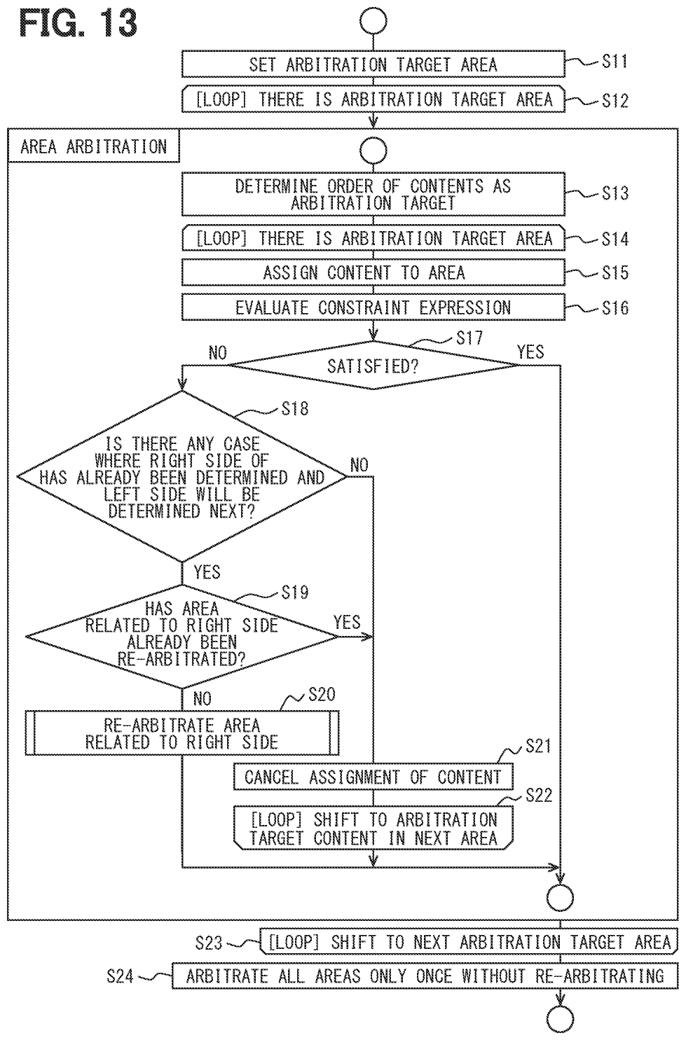

As shown in FIG. 13, the display control device 10 selects an area as an arbitration target in descending order of priority (at S11), and if there is the arbitration target area (at S12), it proceeds to the area arbitration. In the area arbitration, the display control device 10 determines the order of contents as the arbitration target in the area based on the arbitration policy (at S13). If there is no arbitration target area, the loop ends. When there is the content as the arbitration target in the area (at S14), the display control device 10 assigns the content to the area (at S15). If there is no arbitration target area, the loop ends.

The display control device 10 evaluates the constraint expression (at S16), determines whether or not the constraint expression is satisfied (at S17), and exits the area arbitration when determining that the constraint expression is satisfied (“YES” at S17). When the display control device 10 determines that the constraint expression is not satisfied (“NO” at S17), it determines whether or not there is any case where the right side with the implication has already been determined and the left side will be determined next (at S18). When the display control device 10 determines that there is a case (“YES” at S18), it determines whether or not the area related to the right side with the implication has already been re-arbitrated (at S19).

If the display control device 10 determines that there is no case (“NO” at S18), or if there is a case but determined that the area related to the right side with the implication has already been re-arbitrated (“YES” at S19), the display control device 10 cancels the assignment of the content (at S21), shifts to the arbitration target content in the next area (at S22), and exits the area arbitration.

On the other hand, when the display control device 10 determines that the area related to the right side with the implication has not been re-arbitrated yet (“NO” at S19), the display control device 10 adds the area related to the right side with the implication in the order following the arbitration target area (at S20). When the display control device 10 determines that all the loops for shifting to the next arbitration target area have ended and there is no arbitration target area (at S23), the display control device 10 arbitrates only once all the areas without re-arbitrating all the areas (at S24).

3. APP Request

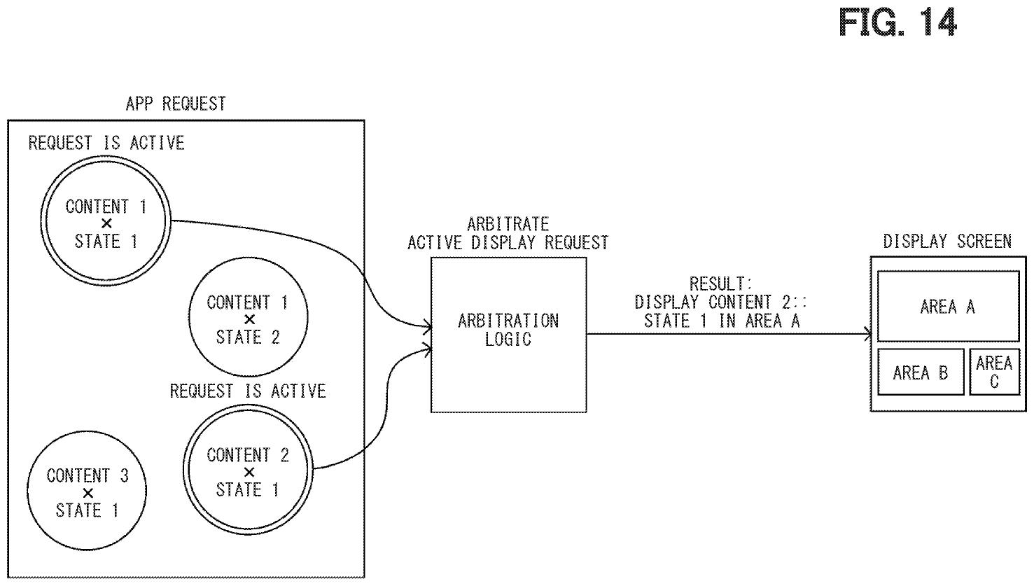

The APP request passes the value of the “content×state” to the arbitration logic as a request from the application, as shown in FIG. 14. The requests do not occur at the same time and always follow an order. It is also influenced to the post-processing that changes the state of the request after arbitration. The arbitration logic arbitrates for the content (and state) in which the APP request occurs. Therefore, the displayed content must at least output an APP request.

An APP request is an APP request for a content, and when an APP request occurs, the corresponding content is arbitrated and displayed in the area after satisfying the constraint expression. Specifically, an APP request is made, and areas to be arbitrated are selected in descending order of area priority. Next, arbitration is performed according to the arbitration policy of each area. That is, the content list is sorted according to the arbitration policy, in order of priority for priority arbitration, and in order of latter win for a latter win arbitration.

Next, the content in the content list and the constraint expression are compared to determine whether the content can be displayed. The content not to be displayed is removed from the list. That is, a content is assigned and a constraint expression is evaluated. In this case, the constraint expressions are evaluated rather than compared, so if all are true, the content assignment is proper. The re-arbitration is performed when there is a possibility that it does not correspond to the intension since the constraint expression evaluation is false and the content assignment is not allowed. Next, display areas are assigned in order of the sorted content list, and the above process is repeated until there are no more areas to be arbitrated.

The timing of sort of the content list is before assigning the content to each area. The content list is created prior to each area assignment. Here, the content that can be displayed is determined for each area. Therefore, the content list is always sorted and filtered by constraint expressions prior to area assignment. That is, it is determined whether or not the area can be assigned.

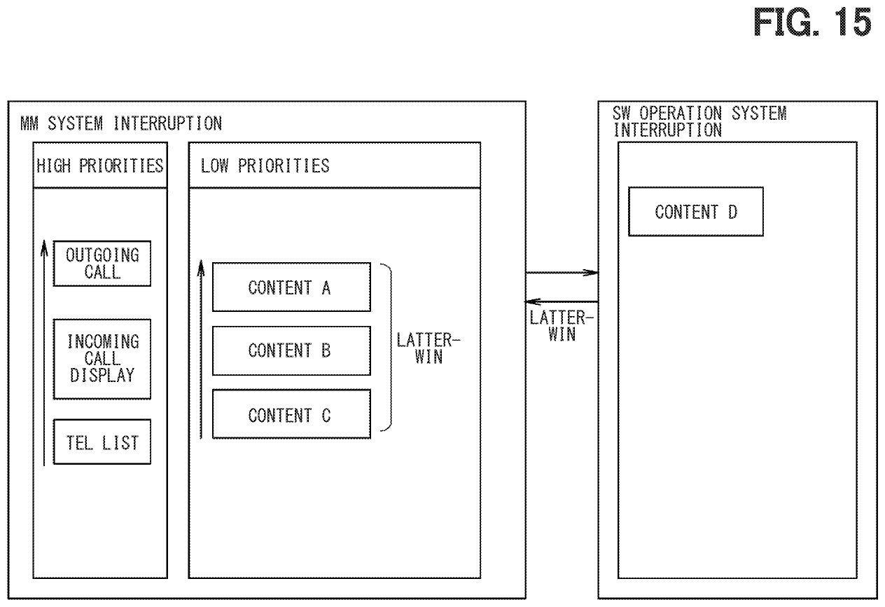

Next, a case of arbitrating the content assigned to one area will be described. As shown in FIG. 15, a multimedia (MM) system interruption and a switch (SW) operation system interruption of the APP request are assumed. When the latter-win arbitration and the priority arbitration coexist, basically the latter-win arbitration is prioritized. However, telephone (TEL) is prioritized in the MM system interruption.

The constraint expression exemplifies “TEL. is Active ( )->For All MM system interruption (other than TEL) {x|!x. is Visible (}”. This is a constraint that if TEL is active, no MM system interruption (other than TEL) is displayed. A TEL content can have three states of “outgoing calling”, “incoming call display”, and “TEL list”, and each state has a different priority. The priorities of contents with low priorities are defined as “the content A>the content B>the content C”.

Content suppression means that no interrupt notification is given while content C is being displayed normally. The constraint expression exemplifies “center. displaying Content ( )=C.->!C notification. is Visible ( )”. This is a constraint that if the content C is displayed in the central display area, the notification of the content C is not displayed. As described above, it is possible to display the content intended by the specification developer in one area.

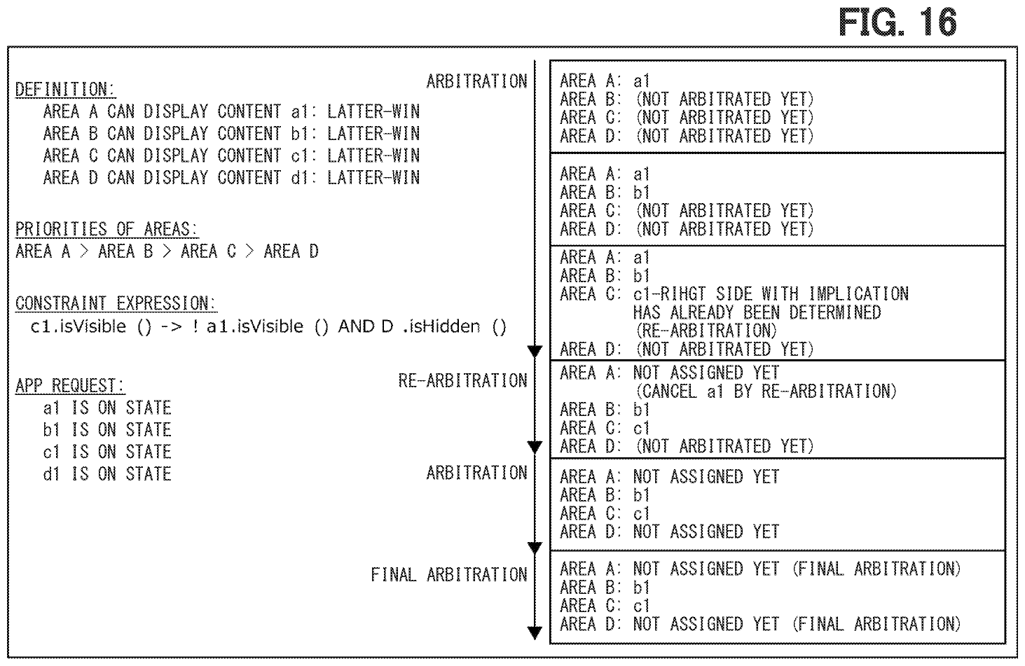

Next, the case of arbitrating the content assigned to multiple areas will be described. As shown in FIG. 16, an area A can display a content a1, an area B can display a content b1, an area C can display a content c1, and an area D can display a content d1. All the areas A to D have the arbitration policy of the latter-win. The priorities between areas is defined as “the area A>the area B>the area C>the area D”.

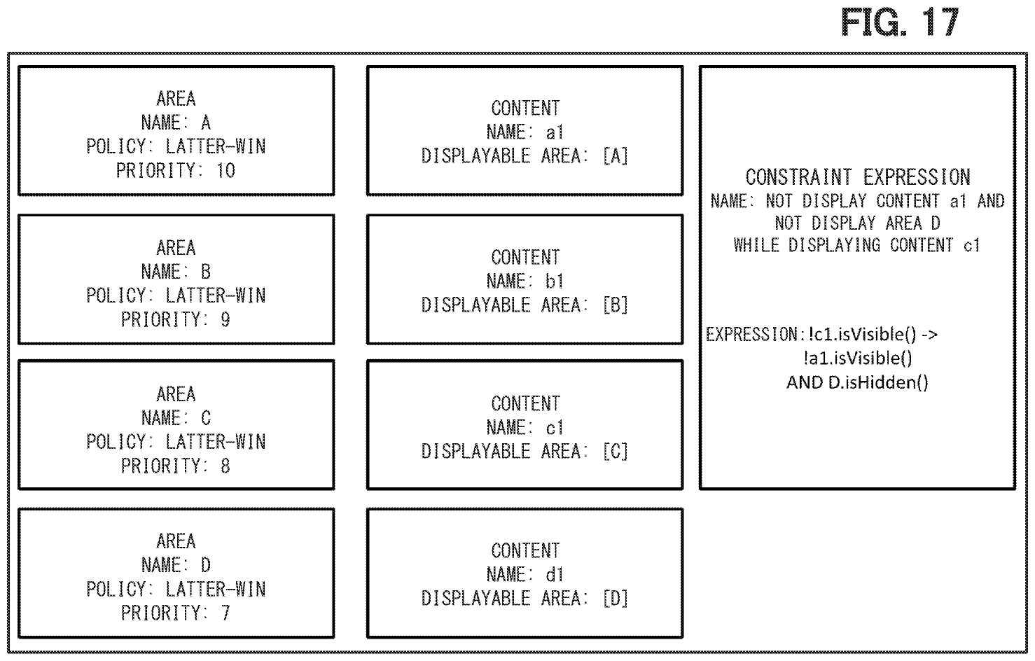

The definitions of the areas, the contents and the constraint expression will be explained. As shown in FIG. 17, a name, an arbitration policy, and a priority are set for each area. In addition, a name and a displayable area are set for each content. The constraint expression exemplifies “c1. is Visible ( )->!a1. is Visible ( ) AND D. is Hidden( )”. The term “is Hidden ( )” means that the area is not displayed even though there is assignable content in the area. This constraint expression describes the suppression that the content a1 is not displayed while the content c1 (i.e., in the area C) is being displayed, and the area D (which interferes with the area C) is hidden.

When the APP requests are turned on in the order of the content a1, the content b1, the content c1, and the content d1, arbitration is performed from area A in order. The content a1 is assigned to the area A according to the arbitration policy. However, this assignment is a tentative assignment since the determination of the constraint expression cannot be performed. Similarly, the content b1 is tentatively assigned to the area B.

In the arbitration in the area C, the content c1 is assigned to the area C according to the arbitration policy, but the right side with the implication in the constraint expression becomes false first. This is because the AND operator will always provide false if one of the two is false.

Therefore, re-arbitration is performed with the content c1 tentatively assigned to the area C, and the re-arbitration is performed so that the evaluation result of the constraint expression becomes true in the area A. There are two result patterns in which the evaluation result of the constraint expression is true. The first result pattern is that when the content c1 is displayed, the content a1 is not displayed and the area D is hidden. The second result pattern is that when the content c1 is not displayed, the evaluation result of the constraint expression is true. The first result patter corresponds to the intention by the specification developer, but the second result pattern is highly likely not to reflect the intention of the specification developer.

In this case, since the right side with the implication has already been determined and the left side is to be determined, re-arbitration is performed. The assignment of the content c1 to the area C is proper, and the re-arbitration in the area on the right side is performed. After the re-arbitration, the area D that has not been arbitrated is arbitrated by returning to the order of the original arbitration. In this case, the area D must be not displayed (i.e., unassigned) in order for the right side of the constraint expression to be true. After that, arbitration is performed only once at the end without re-arbitration. This is an arbitration mainly for unassigned areas. As described above, it is possible to display the contents intended by the specification developer in multiple areas.

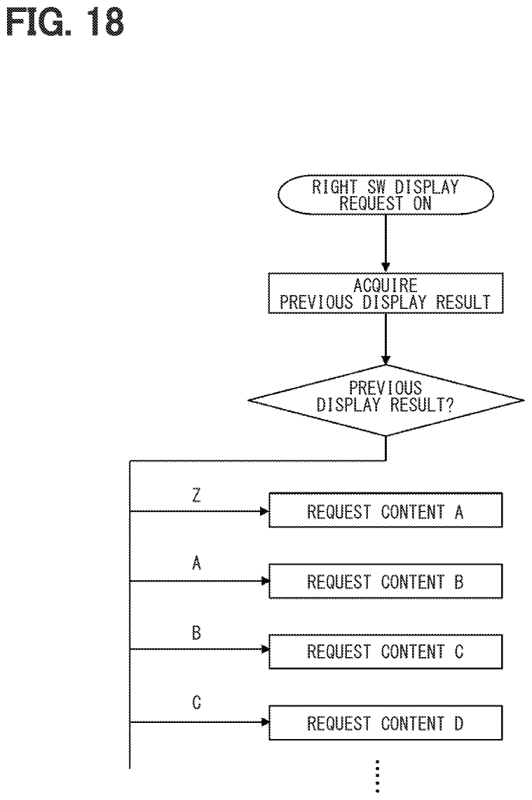

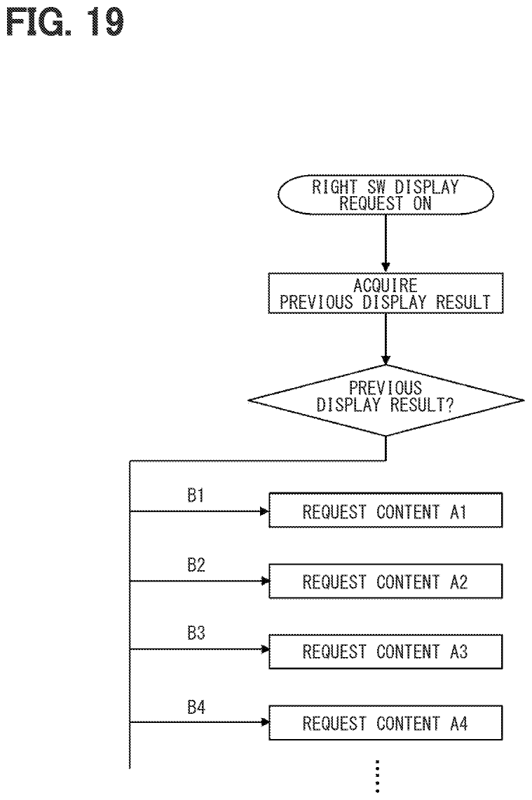

By the way, in a technology of determining winning or losing of contents with respect to areas, since a content that has lost in arbitration is not displayed, it is necessary to manage a request or perform a complicated arbitration evaluation on an application side. Specifically, in order to display the contents while switching the contents as in the tab screen, it is necessary to switch the display request from the application side. In this case, processes illustrated in FIG. 18 and FIG. 19 are performed.

FIG. 18 illustrates a mode in which one application displays a plurality of contents in a loop in one area. In this case, when the display request by a right switch operation is turned on, the application side needs to acquire a previous display result, determine the acquired previous display result, and determine a next display request according to the determination result. However, this complicates the design and implementation. FIG. 19 illustrates a mode in which a plurality of applications display a plurality of contents in a loop in one area. Also in this case, when the display request by the right switch operation is turned on, the application side needs to acquire the previous display result, determine the acquired previous display result, and determine the next display request according to the determination result. However, in this case, it is necessary for each application to consider the result of another application, and the system may become a dense design, and the ease of changing the specification and the design may be lost.

In view of such circumstances, in the present embodiment, in order to perform loop display or continuous display of contents belonging to a specific group, not the winning or losing of the contents but the display order of the contents is determined, and content arbitration is performed according to the determination result. Specifically, the arbitration unit 13 evaluates the evaluation target group and evaluates the order criteria of the contents belonging to the evaluation target group to determine the display order of the contents. When the display order is determined, the arbitration unit 13 stores the display order and the current display position, performs arbitration of the contents so as to satisfy the rule-based arbitration, and changes the display position and switches the contents to be displayed every time the arbitration is performed (corresponding to an arbitration procedure). When content arbitration is performed by the arbitration unit 13, the display control unit 14 controls display of the content assigned to the area (corresponding to an output control procedure).

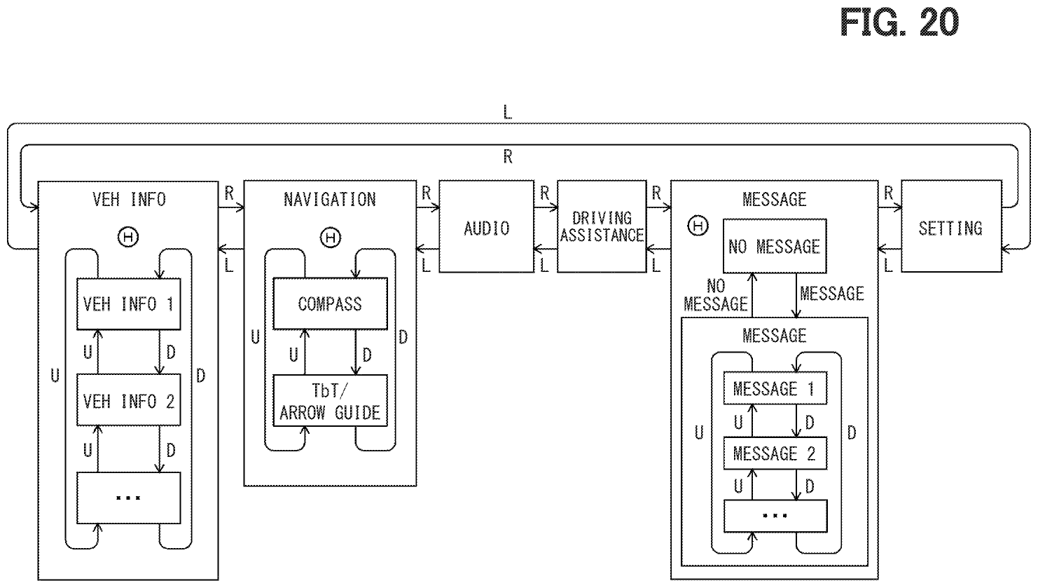

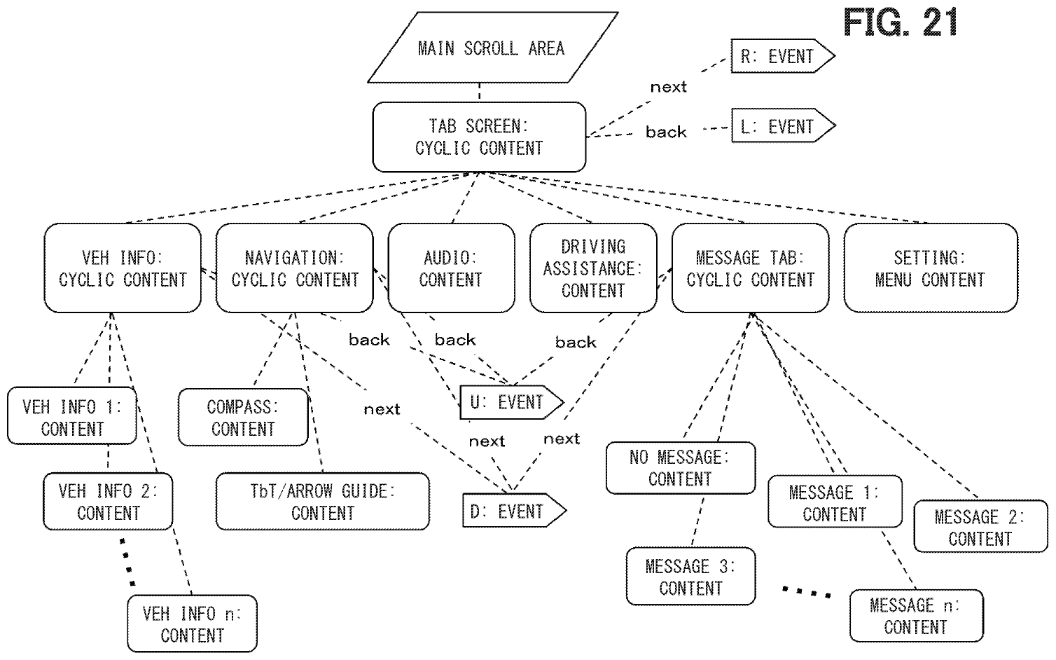

A state transition illustrated in FIG. 20 and an object configuration illustrated in FIG. 21 will be described as examples. Contents of vehicle information, a navigation, an audio, a driving assistance, a message, and a setting cyclically transition when an event is caused by the operation of a right switch (R) or the operation of a left switch (L). For example, while the content of the vehicle information is being displayed, each time the right switch is operated, the display of the content is cyclically switched according to the order of the navigation, the audio, the driving assistance, the message, and the setting. Conversely, each time the left switch is operated, the display of the content is cyclically switched according to the order of the setting, the message, the driving assistance, the audio, and the navigation. In the contents of the vehicle information (VEH INFO), vehicle information 1, vehicle information 2, . . . , and vehicle information n cyclically transition according to the occurrence of an event caused by the operation of an up switch (U) or the operation of a down switch (D). Similarly, in the contents of the navigation, a compass and a TbT/arrow guide cyclically transition according to the occurrence of the event caused by the operation of the up switch or the operation of the down switch. In the contents of the message, a message 1, a message 2, . . . , and a message n cyclically transition due to the occurrence of the event caused by the operation of the up switch or the operation of the down switch.

“A tab screen” is defined as a cyclic content. The cyclic content means a content displayed in a cyclic manner. “The tab screen” is displayed in a main scroll area. In “the tab screen”, the content to be displayed is cyclically switched according to the occurrence of the event caused by the operation of the right switch or the left switch. The contents that can be displayed on “the tab screen” are the vehicle information, the navigation, the audio, the driving assistance, the message, and the setting. The vehicle information, the navigation, and the message are also defined as cyclic contents, and the contents to be displayed are cyclically switched by the occurrence of the event caused by the operation of the up switch or the down switch.

In the cyclic display, switching display of the messages every two seconds, the tab screen transition, and the like are realized. The cyclic display is dealt with by defining a cyclic dedicated content. A function of the cyclic content defines a content that can be displayed as the cyclic content. In the cyclic content, an arrangement order policy as the order criterion is defined, and one of a former-win, a latter-win, a priority-former-win, or a priority-latter-win is defined. The former-win is an order criterion in which a former request in a plurality of requests is output preferentially. The latter-win is an order criterion in which a latter request in a plurality of requests is output preferentially. The priority-former-win is an order criterion in which a request having a higher priority in a plurality of requests is output preferentially, but if there are requests with the same priority, a former request is output preferentially. The priority-latter-win is an order criterion in which a request having a higher priority in a plurality of requests is output preferentially, but if there are requests with the same priority, a latter request is output preferentially. Active content (requested from the application) among the defined contents is displayed in accordance with the arrangement order policy. In the cyclic content, a next event (the operation of the right switch, two seconds elapse, or the like) and a return event (the operation of the left switch or the like) are defined. When the next event occurs, the display is switched to the next content, and when the return event occurs, the display is switched to the previous content. The cyclic content has a cyclic attribute. When the next event occurs while the last content is being displayed, the display is switched to the first content, and when the return event occurs while the first content is being displayed, the display is switched to the last content. The first content has the same meaning as a head content, and the last content has the same meaning as a tail content.

Selection of the evaluation target group is determined by the following constraint expression.

activeContents( )

The meaning of the constraint expression is “acquire an active content from objects that can define a displayable content, such as areas, cyclic content, and the like”.

select {x|<expression>}

The meaning of the constraint expression is “extracting a subset of elements satisfying the constraint expression from a set”.

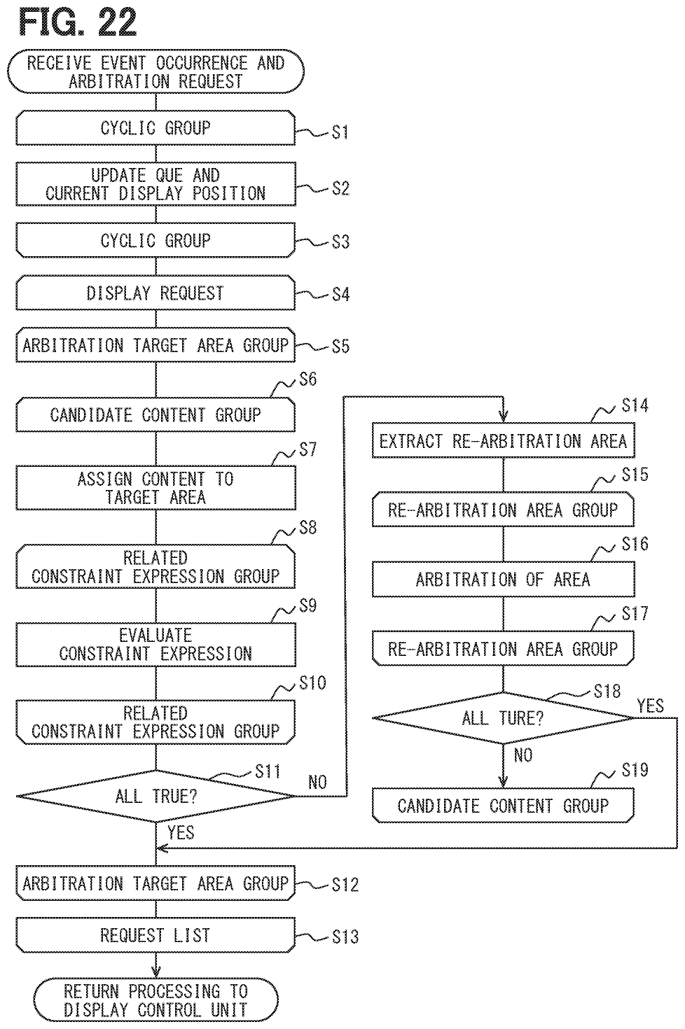

The display control device 10 performs a process illustrated in FIG. 22. Upon receiving the event occurrence or the arbitration request, the display control device 10 updates a queue and a current display position for a cyclic group that is the evaluation target group (S1 to S3).

When the update of the queue and the update of the current display position are performed for the cyclic group, the display control device 10 assigns the content to the target area for the arbitration target area group and the candidate content group in accordance with the request list and evaluates a related constraint expression group that is a related constraint expression as in the related art. When it is determined that all the evaluation results are true, the display control device 10 returns the processing to the display control unit 14 (S4 to S13).

When it is determined that not all the evaluation results are true, that is, when it is determined that any one of the evaluation results is false, the display control device 10 extracts a re-arbitration area and performs arbitration of the area of the re-arbitration area group. When it is determined that all the arbitration results are true, the display control device 10 returns the processing to the display control unit 14 (S14 to S18, S12, S13). When it is determined that not all the arbitration results are true, that is, when it is determined that any one of the arbitration results is false, the display control device 10 re-assigns the content to the target area (S19), and repeats the above-described processing.

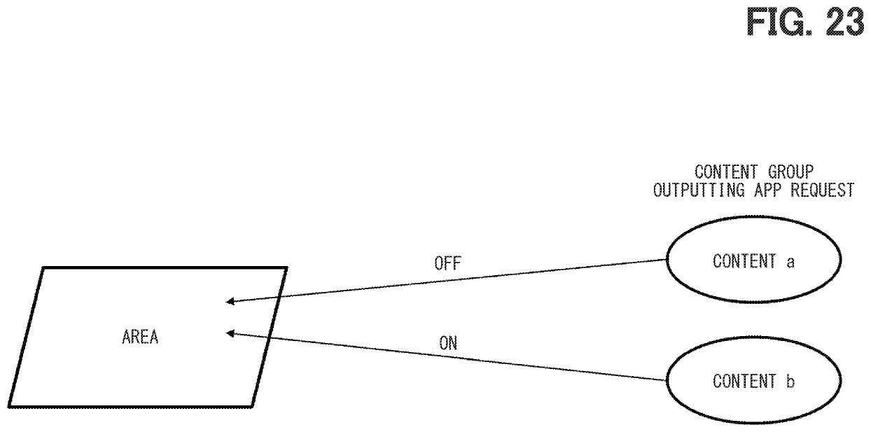

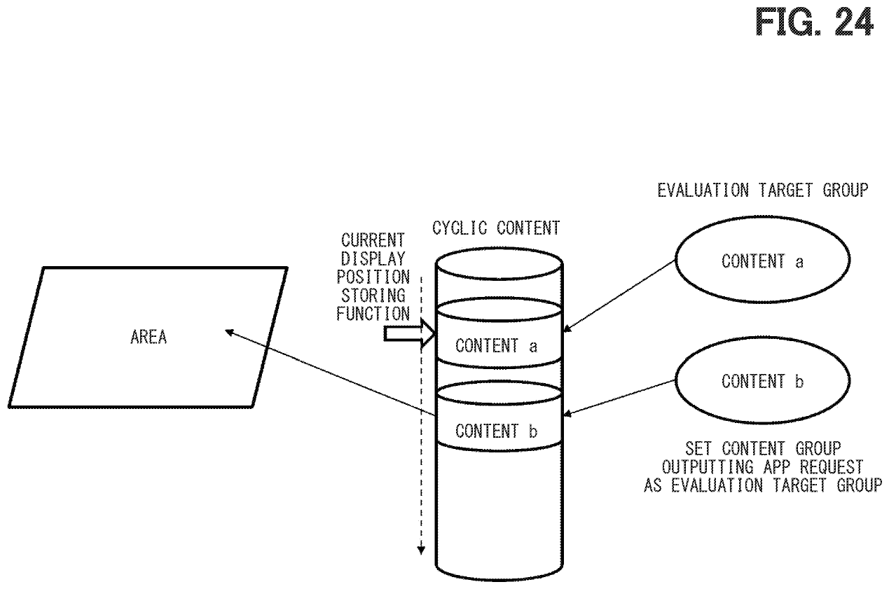

Hereinafter, advantages of the present embodiment will be described. As illustrated in FIG. 23, in a configuration according to the conceivable technique in which switching of contents is performed on the application side, it is necessary to output OFF and ON of the APP request, and the arbitration unit 13 needs to perform arbitration for OFF of the APP request, and perform arbitration for ON of the APP request. Thus, the arbitration unit 13 needs to perform arbitration two times. In contrast, in the present embodiment, as illustrated in FIG. 24, the arbitration unit 13 sets the content group that has output the APP request as the evaluation target group, accumulates the content group in a queue of the cyclic content, and selects one content from the queue of the cyclic content by a function of storing a current display position as preprocessing for assigning the content to an area. Thus, the arbitration unit 13 of the present embodiment only needs to perform arbitration once, and the number of performing arbitration can be reduced to one.

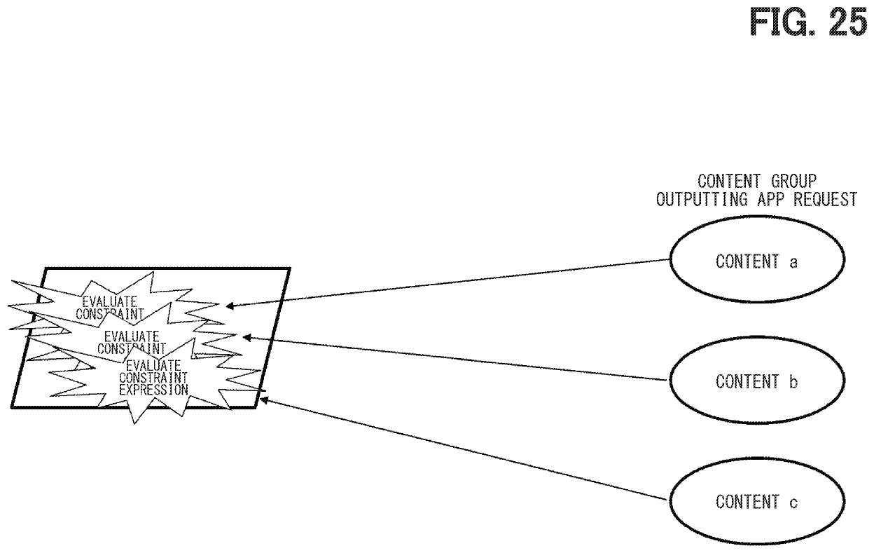

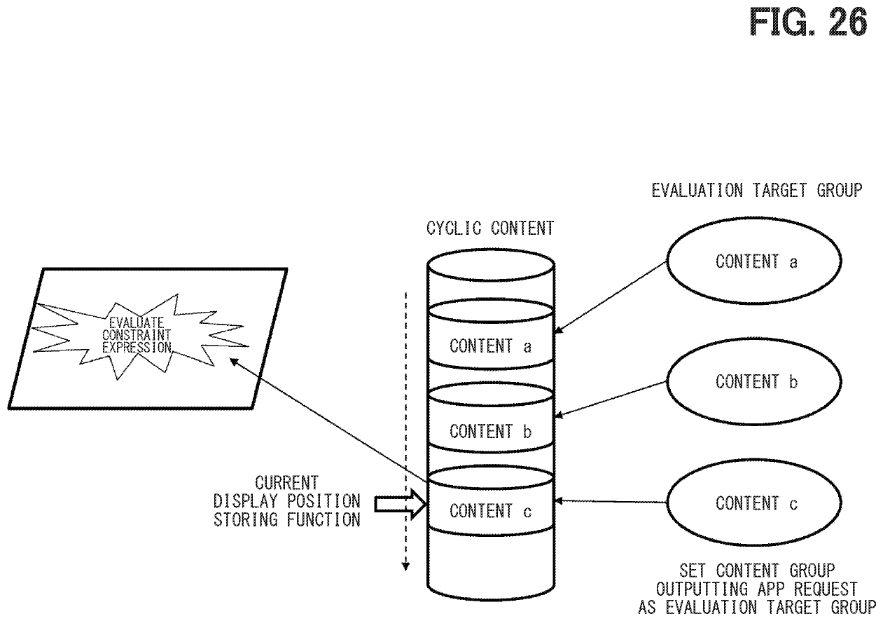

In addition, in the configuration according to the conceivable technique, as illustrated in FIG. 25, the arbitration unit 13 determines the assignment of the content with respect to one APP request by setting all the constraint expressions as evaluation targets, and the processing time is long. On the other hand, in the present embodiment, as illustrated in FIG. 26, the evaluation of the evaluation target group and the evaluation of the order criterion are performed in advance, so that all the constraint expressions are not set as the evaluation targets, the number of constraint expressions to be evaluated can be reduced, and the processing time can be shortened.

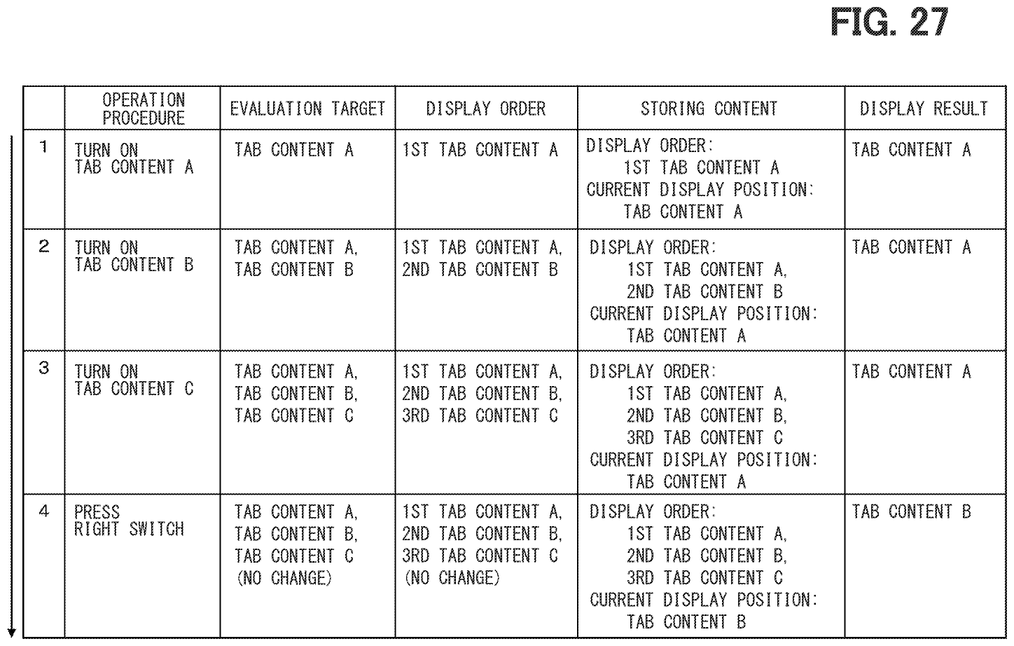

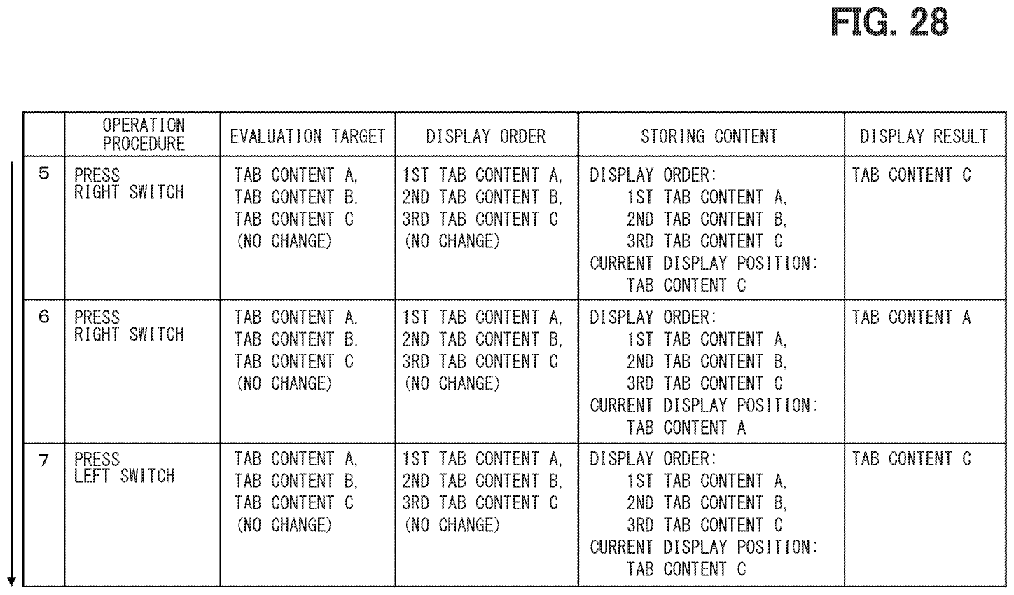

Specifically, a flow of processing when cyclic display is performed for the following model will be described with reference to FIG. 27 and FIG. 28. The conditions of the model are as follows.

Area: a tab area

Contents: a tab content A, a tab content B, and a tab content C

Evaluation target group: a content group for which a display request has occurred

Order criterion: the former-win

Display switching trigger: an advance direction (a right switch), a return direction (a left switch)

The operation procedure is as follows.

Operation procedure 1: turn on the tab content A

Operation procedure 2: turn on the tab content B

Operation procedure 3: turn on the tab content C

Operation procedure 4: press the right switch

Operation procedure 5: press the right switch

Operation procedure 6: press the right switch

Operation procedure 7: press the left switch

The results of each operation procedure are shown below.

(1) Operation Procedure 1 (Turn on the Tab Content A)

According to the evaluation of “the evaluation target group: the content group for which the display request has occurred”, the evaluation target is only “the tab content A”. According to the evaluation of “the order criterion: the former-win”, the display order becomes “the first is the tab content A”. “The display order: the first is the tab content A” and “the current display position: the tab content A” are stored. The display result of the tab area is “the tab content A”.

(2) Operation Procedure 2 (Turn on the Tab Content B)

According to the evaluation of “the evaluation target group: the content group for which the display request has occurred”, the evaluation target is “the tab content A, the tab content B”. According to the evaluation of “the order criterion: the former-win”, the display order is “the first is the tab content A, and the second is the tab content B”. “The display order: the first is the tab content A, and the second is the tab content B” and “the current display position: the tab content A” are stored. The display result of the tab area remains “the tab content A”.

(3) Operation Procedure 3 (Turn on the Tab Content C)

According to the evaluation of “the evaluation target group: the content group for which the display request has occurred”, the evaluation target is “the tab content A, the tab content B, and the tab content C”. According to the evaluation of “the order criterion: the former-win”, the display order is “the first is the tab content A, the second is the tab content B, and the third is the tab content C”. “The display order: the first is the tab content A, the second is the tab content B, and the third is the tab content C” and “the current display position: the tab content A” are stored. The display result of the tab area remains “the tab content A”.

(4) Operation Procedure 4 (Press the Right Switch)

There is no change in the order evaluation result. Since the display switching trigger corresponds to the advance direction, the current display position is switched to the next tab content, and “the tab content A” is switched to “the tab content B”. “The display order: the first is the tab content A, the second is the tab content B, and the third is the tab content C” and “the current display position: the tab content B” are stored. The display result of the tab area is switched from “the tab content A” to “the tab content B”.

(5) Operation Procedure 5 (Press the Right Switch)

There is no change in the order evaluation result. Since the display switching trigger corresponds to the advance direction, the current display position is switched to the next tab content, and “the tab content B” is switched to “the tab content C”. “The display order: the first is the tab content A, the second is the tab content B, and the third is the tab content C” and “the current display position: the tab content C” are stored. The display result of the tab area is switched from “the tab content B” to “the tab content C”.

(6) Operation Procedure 6 (Press the Right Switch)

There is no change in the order evaluation result. Since the display switching trigger corresponds to the advance direction, the current display position is switched to the next tab content, and “the tab content C” is switched to “the tab content A”. That is, since “the tab content C” is at the lowest level, “the tab content C” is switched to “the tab content A” at the highest level. “The display order: the first is the tab content A, the second is the tab content B, and the third is the tab content C” and “the current display position: the tab content A” are stored. The display result of the tab area is switched from “the tab content C” to “the tab content A”.

(7) Operation Procedure 7 (Press the Left Switch)

There is no change in the order evaluation result. Since the display switching trigger corresponds to the return direction, the current display position is switched to the immediately previous tab content, and “the tab content A” is switched to “the tab content C”. That is, since “the tab content A” is at the highest level, “the tab content A” is switched to the “the tab content C” at the lowest level. “The display order: the first is the tab content A, the second is the tab content B, and the third is the tab content C” and “the current display position: the tab content C” are stored. The display result of the tab area is switched from “the tab content A” to “the tab content C”.

As described above, it is possible to easily realize the tab screen specification by the order determination and switching method using the cyclic function instead of the winning or losing of the contents.

According to the present embodiment, the following effects can be obtained. In the display control device 10, instead of determining the winning or losing of the contents with respect to the area, the display order of the contents is determined, and the arbitration of the contents is performed using the determination result. By defining the display order of the content in advance, the display of the contents can be switched according to the display order of the contents. As a result, it is possible to appropriately display the contents as intended by the specification developer without requiring management of the display request or complicated arbitration evaluation on the application side.

The display order of the contents is determined by evaluating the evaluation target group and evaluating the order criteria of the contents belonging to the evaluation target group. By defining the evaluation target group and the order criterion of the contents, the display order of the contents can be determined. When the display order of the contents is determined, the display order and the current display position are stored, and the current display position is changed every time arbitration is performed to switch the contents to be displayed. The display of the contents can be switched by changing the current display position. The display order of the contents can be determined by defining any one of the former-win, the latter-win, the priority-former-win, or the priority-latter-win as the order criterion.

Although the present disclosure has been made in accordance with the embodiments, it is understood that the present disclosure is not limited to such embodiments and structures. The present disclosure incorporates various modifications and variations within a scope of equivalents. Additionally, various combinations and configurations, as well as other combinations and configurations including more, less, or only a single element, are within the scope and spirit of the present disclosure.

It may be applied not only to the vehicle but also to the content display control device for purposes other than the vehicle.

The controller and the method according to the present disclosure may be achieved by a dedicated computer provided by constituting a processor and a memory programmed to execute one or more functions embodied by a computer program. Alternatively, the controllers described in the present disclosure and the methods thereof may be realized by a dedicated computer configured as a processor with one or more dedicated hardware logic circuits. Alternatively, the controller and methods described in the present disclosure may be realized by one or more dedicated computer, which is configured as a combination of a processor and a memory, which are programmed to perform one or more functions, and a processor which is configured with one or more hardware logic circuits. The computer program may be stored in a computer-readable non-transitory tangible storage medium as an instruction to be executed by the computer.

What is claimed is:

1. A content output control device comprising:
a memory that stores a rule definition including: an arbitration policy for defining basic arbitration when one of a plurality of contents is assigned to an area or a zone; and a constraint expression;
an arbitration unit configured to perform arbitration of the plurality of contents according to the rule definition to satisfy a rule-based arbitration upon receiving an output request from an application; and
an output control unit configured to control an output of the one of the plurality of contents assigned to the area or the zone due to the arbitration of the plurality of contents by the arbitration unit, wherein
the arbitration unit is configured to determine an output order of the plurality of contents, and to perform the arbitration of the plurality of contents by using a result of determining the output order so as to satisfy the rule-based arbitration, instead of setting contents belonging to a specific group as target contents and determining winning or losing of the target contents according to the rule definition.

2. The content output control device according to claim 1, wherein
the arbitration unit is configured to evaluate an evaluation target group,
the plurality of contents includes one or more contents belonging to the evaluation target group, and
the arbitration unit is configured to evaluate an order criterion of the one or more contents belonging to the evaluation target group to determine an output order of the one or more contents.

3. The content output control device according to claim 2, wherein
when the arbitration unit determines the output order of the one or more contents, the arbitration unit stores the output order and a current output position, and changes the current output position every time the arbitration is performed to switch a content to be output in the plurality of contents.

4. The content output control device according to claim 2, wherein
the arbitration unit is configured to evaluate whether the order criterion is a former-win, a latter-win, a priority-former-win, or a priority-latter-win.

5. A content output control method in a content output control device including a memory that stores a rule definition including: an arbitration policy defining a basic arbitration when one of a plurality of contents is assigned to an area or a zone; and a constraint expression, the content output control method comprising:
an arbitration procedure for determining an output order of the plurality of contents upon receiving an output request from an application, and performing arbitration of the plurality of contents according to the rule definition using a result of determining the output order so as to satisfy a rule-based arbitration, instead of setting contents belonging to a specific group as target contents and determining winning or losing of the target contents according to the rule definition; and
an output control procedure for controlling an output of the one of the plurality of contents assigned to the area or the zone due to the arbitration of the plurality of contents in the arbitration procedure.

6. A non-transitory computer readable storage medium comprising instructions being executed by a computer in a content output control device including a memory that stores a rule definition, the rule definition including: an arbitration policy defining a basic arbitration when one of a plurality of contents is assigned to an area or a zone; and a constraint expression, the instructions causing the computer to execute:
an arbitration procedure for determining an output order of the plurality of contents upon receiving an output request from an application, and performing arbitration of the plurality of contents according to the rule definition using a result of determining the output order so as to satisfy a rule-based arbitration, instead of setting contents belonging to a specific group as target contents and determining winning or losing of the target contents according to the rule definition; and
an output control procedure for controlling an output of the one of the plurality of contents assigned to the area or the zone due to the arbitration of the plurality of contents in the arbitration procedure.
